(19) United States
(12) Patent Application Publication
(10) Pub. No.: US 2022/0243815 A1
(43) Pub. Date: Aug. 4, 2022

(54) COMBUSTION CYLINDER HEAD GASKET

(71) Applicant: TENNECO INC., Lake Forest, IL (US)

(72) Inventors: JAMES ZWICK, BRIGHTON, MI (US); JEASON SUN, SHANGHAI (CN); TAKASHI OKANO, COMMERCE TOWNSHIP, MI (US)

(21) Appl. No.: 17/165,630

(22) Filed: Feb. 2, 2021

(51) Int. Cl. F16J 15/08

(52) U.S. Cl. CPC F16J 15/0825; F16J 2015/0856

(57) ABSTRACT

A multi-layer steel gasket includes a pair of outermost steel layers having a plurality of combustion openings. The outermost layers are generally planar and free of elastic beads in a compression region of the gasket immediately surrounding the combustion openings. A pair of metal sealing rings are associated with each of the combustion openings and are disposed between the outermost layers and are formed with opposed full beads that face away from one another in the compression region of the gasket around each cylinder opening. The sealing rings each having a thickness of at least 0.3 mm and which is greater than a thickness of the outermost layer. At least one distance layer is disposed between the outermost layers, wherein when the compression region is fully compressed, the thickness of the combined layers of gasket in the compression region is greater than the thickness of the combined layers of the gasket in a body of the gasket adjacent the compression region.

### BACKGROUND OF THE INVENTION

### 1. Technical Field

This invention relates generally to cylinder head gaskets from internal combustion engines.

### 2. Related Art

Multilayer steel (MLS) cylinder head gaskets are known to be used between the head and the block on an engine to effect a fluid-tight seal of the combustion cylinders. More demand is placed on such MLS gaskets with rising engine temperatures and pressures calling for stronger gaskets that can withstand the conditions. A common approach for increasing the strength of a gasket is to add one or more additional layers to the gasket, but each gasket layer poses a risk for leakage as each layer introduces two more interfaces that may be prone to leakage.

### SUMMARY OF THE INVENTION

A cylinder head gasket for an internal combustion engine includes a plurality of metallic gasket layers defining a plurality of combustion openings and including a sealing areas of the gasket encircling each cylinder opening and a body area of the gasket away from the sealing areas. The plurality of metallic gasket layers include a pair of outermost layers, a pair of inner layers and at least one distance layer. The inner layers include ring-shaped sealing portions surrounding each of the cylinder openings having full bead embossments that project away from one another toward the outermost layers. The sealing portions have a material thickness of at least 0.3 mm and the combined material thickness of all layers of material in the sealing areas is greater than a combined material thickness of all layers of material in the body of the gasket adjacent the sealing areas.

According to another aspect, a multilayer steel cylinder head gasket for an internal combustion engine includes a pair of outermost layers fabricated of a first steel material having a first hardness and a first thickness. The pair of first layers includes a plurality of combustion cylinder openings. An intermediate layer is provided and is fabricated of a second steel material having a second hardness and second thickness. The intermediate layer includes an inner edge that surrounds each or all of the plurality of combustion cylinder openings of the outermost layers in radially outwardly spaced relation thereto. Also provided is a pair of opposing elastic sealing rings associated with each of the plurality of combustion cylinder openings. The sealing rings are each fabricated of a third steel material having a third hardness and each are formed with a full bead embossment the encircles the associated combustion cylinder openings, and with the full bead embossments of each pair of sealing rings projecting away from one another toward the outermost layers. The sealing rings are radially inset in relation to the inner edge of the intermediate layer. The outermost layers and sealing rings are made of the same stainless steel material and also have the same hardness. The material of the intermediate layer is different than that of the outermost layers and sealing rings and has a relatively lower hardness. The sealing rings each have a thickness of at least 0.3 mm which is relatively greater than the thickness of each of the outermost layers. The intermediate layer has a thickness that is greater than the thickness of each of the sealing rings and outermost layers. The thickness of the intermediate layer is less than twice the material thickness of each of the sealing rings.

### THE DRAWINGS

These and other features and advantages will be better understood when considered in connection with the following detailed description and drawings representing non-limiting embodiments, in which:

FIG. 1 is a plan view of a gasket according to an embodiment;

FIG. 2 is a schematic enlarged cross-sectional view taken along lines 2-2 of FIG. 1;

FIG. 3 is a view like FIG. 2 but shown in a fully compressed condition in use;

FIG. 4 is a plan view of a distance layer component of the gasket;

FIG. 5 is a plan view of a plurality of sealing ring components of the gasket;

FIG. 6 is an enlarged cross-sectional view taken along lines 6-6 of FIG. 1;

FIG. 7 is a schematic fragmentary cross-sectional view of a second embodiment;

FIG. 8 is a schematic fragmentary cross-sectional view of a third embodiment;

FIG. 9 is a schematic fragmentary cross-sectional view of a fourth embodiment; and

FIG. 10 is a schematic fragmentary cross-sectional view of a fifth embodiment.

### DETAILED DESCRIPTION

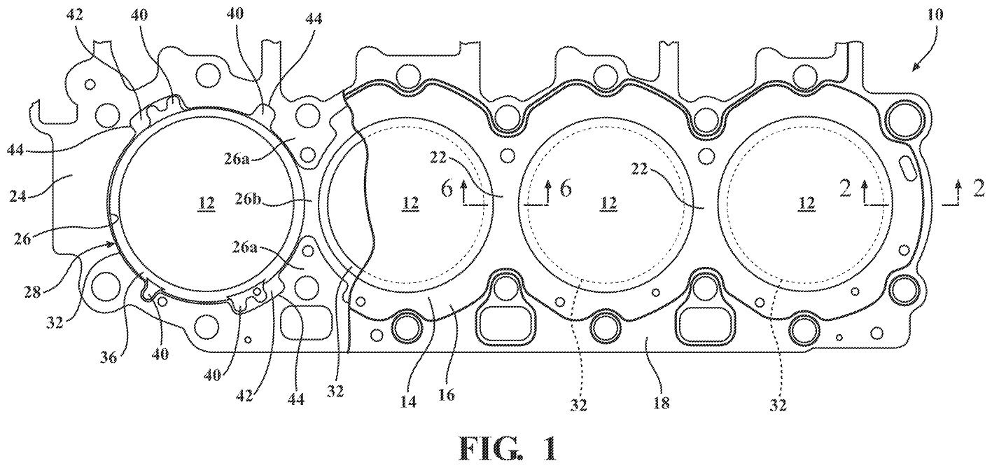

A gasket for an internal combustion engine is generally shown at 10 in FIG. 1. The gasket 10 is a multilayer steel gasket and more particularly a multilayer steel cylinder head gasket of the general type used for effecting a fluid tight seal of combustion cylinders of the engine at an interface between a cylinder head and engine block of the engine. The gasket 10 includes a plurality of combustion cylinder openings 12 that correspond in number and arrangement to the combustion cylinders of the engine. The exemplary gasket 10 is shown to have four such cylinder openings 12, but it is contemplated that more or fewer openings 12 may be provided as called for by the particular engine application.

The cylinder head gasket 10 includes a plurality of metallic gasket layers to be described in greater detail below. The gasket 10 includes sealing areas 14 that immediately surround the combustion cylinder openings 12. A body area 16 of the gasket 10 borders the sealing areas 14. As will also be explained in more detail below, the layers that make up the gasket have predetermined material thicknesses and the stack-up dimension of the layers in the sealing area 14 is greater than the stack-up dimension of the layers outside the sealing areas 14, namely in the body area 16 of the gasket 10.

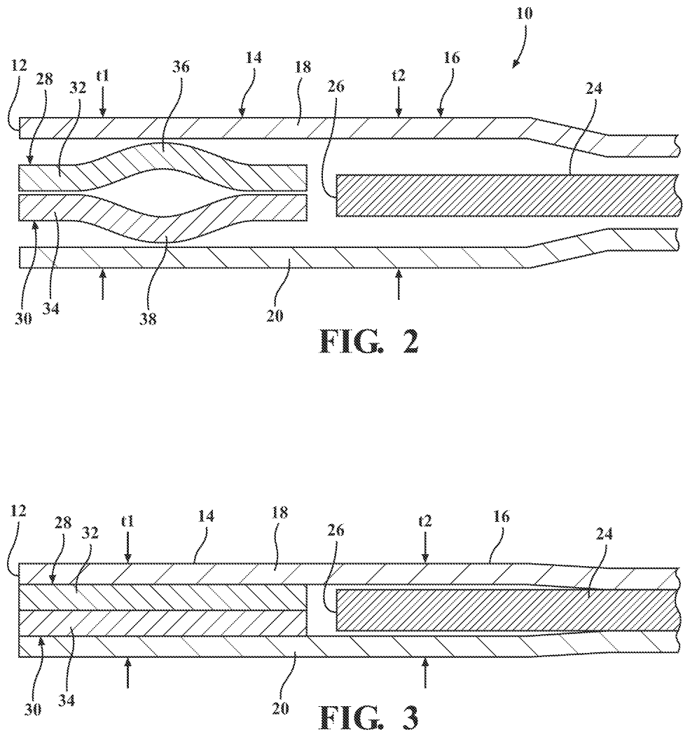

Further details of a first embodiment of the gasket 10 are illustrated in FIGS. 2-6. The gasket 10 includes a pair of outermost metallic layers 18, 20 which may also be referred to as upper and lower layers 18, 20. These layers 18, 20 are on the outside of the gasket and their outward facing surfaces engage the head and block of the engine and may be fully or partially coated with one or more materials, such as fluoropolymer or other sealants. The outermost layers 18, 20 include a plurality of openings corresponding in number and placement to the cylinder openings 12 of the gasket 10. The outermost layers 18, 20 extend continuously around and in between the openings 12, such that the openings 12 in the layers 18, 20 are discrete and fully encircled by the material of the layers 18, 20, including web portions 22 of the outermost layers 18, 20 which extend between and separate adjacent pairs of the openings 12. In the embodiment shown, there are four openings 12 and as such there are three corresponding web portions 22 that separate the openings 12. Other openings may be provided in the gasket for conveying fluids and receiving fasteners and the like in accordance with well-known practice in the art of cylinder head gaskets.

The outermost layers are fabricated of a stainless steel material and are of a predetermined material thickness t₁ and material hardness. The material composition and properties of the outer layers 18, 20 are preferably the same, that is, they are made of the same steel alloy composition, have the same hardness and the same thickness. The preferred material for the outermost layers 18, 20 is full hard SS301 having an uncoated material thickness t₁ of 0.25 mm+/−0.012.

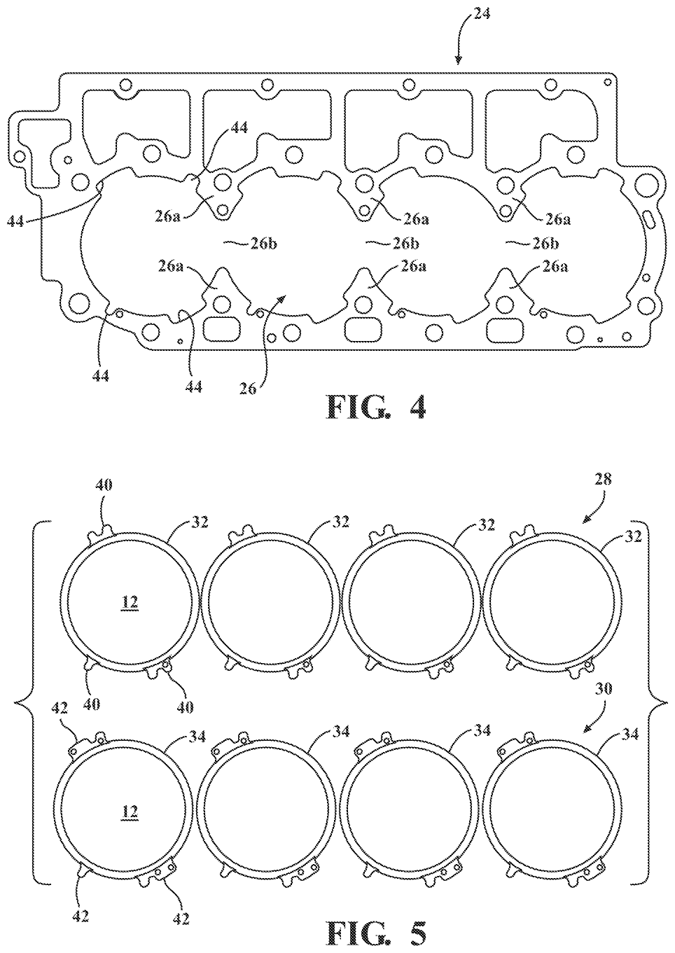

The gasket 10 includes a distance layer 24 arranged between the outermost layers 18, 20. The distance layer 24 includes necessary openings and passages, as needed, to enable the gasket to allow the sealed passage of gases and fluids through the gasket 10. At least one opening 26 is defined by an inner edge of the distance layer and communicates with the cylinder openings 12 of the gasket. However, unlike the fully closed cylinder openings provided by the outermost layers 18, 20, the material of the distance layer 24 does not extend fully between adjacent cylinder openings 12, giving the opening 26 an undulating shape across the cylinder openings 12, including scalloped portions 26a that project inwardly toward one another from opposite sides between adjacent cylinder openings 12 but are spaced apart across intervening gaps 26b in the narrowing part of adjacent cylinders 12 where there is no distance layer material present, but where there are the web portions 22 of the overlying outermost layer material 18, 20. FIGS. 4 and 6 illustrate features of the distance layer 24.

The gasket 10 also includes a pair of intermediate functional layers 28, 30 associated with each cylinder opening 12. The intermediate layers 28, 30 are disposed between the outermost layers 18, 20 and comprise sealing rings or ring portions 32, 34 that encircle each opening 12. The sealing rings 32, 34 are each formed with a full bead embossment 36, 38 that are circumferentially continuous and project out of the plane of each sealing ring. The sealing rings 32, 34 for each cylinder opening 12 are arranged in stacked pairs and are oriented with the beads 36, 38 opposed, aligned and projecting away from one another toward the outermost layers 18, 20. There are preferably no other bends, folds or deformations in the sealing rings 32, 34 according to this embodiment and they are essentially annular in construction but may and preferably do include radial tabs 40, 42 which project radially outwardly of the seal rings 32, 34. The tabs 40, 42 are captured between the outermost layers 18, 20 and serve as a poka-yoke alignment aid during assembly of the gasket 10. When the sealing rings 32,34 of each set are properly oriented with their full beads 32, 34 aligned and projecting away from one another, the tabs 40, 42 are able to nest within associated cut-outs or slots 44 provided along the edge of the opening 26 of the distance layer 24. The shape and location of the tabs 40, 42 and gaps 44 assure that the sealing rings 32, 34 can be installed only in the proper orientation or else the tabs 40, 42 will not register with the slots 44 to assure optimum function and performance of the gasket 10 in use.

In the first embodiment, the distance layer 24 is generally planar and is adjacent to but does not directly engage the sealing rings 32, 34, apart from receiving the tabs 40, 42 in the slots 44. The sealing rings 32, 34 are radially inset from the inner edge 26 opening of the distance layer 24, apart from the nesting of the alignment tabs 40, 42. The beads 36, 38 of the sealing rings 32, 34 extend above opposite upper and lower surfaces of the distance layer 24, preferably by an equal amount in either side. The centerline plane of the distance layer 24 extends between the two sealing rings 32, 34 such that they are opposed on opposite sides of the plane.

The outermost layers 18, 20 are fabricated of a first steel material. The distance layer 24 is fabricated of a second steel material. The sealing rings 32, 34 are fabricated of a third steel material.

The outermost layers 18, 20 and sealing rings 32, 3 are made of the same stainless steel material and have the same material hardness. The material of the distance layer 24 is different than the material of the outermost layers 18, 20 and rings 32, 34, and the material of the distance layer 24 has a relatively lower hardness.

The sealing rings 32, 34 each have a material thickness t2 that is greater than the material thickness t1 of each of the outermost layers 18, 20. The material thickness t2 of the sealing rings 32, 34 is equal to or greater than 0.3 mm, and more preferably 0.35+/−0.015 mm. The thickness t3 of the distance layer 24 is greater than the thickness of each of the sealing rings 32, 34 and outermost layers 18, 20, but is less than twice the thickness of each of the sealing rings 32, 34.

The preferred material for the outermost layers 18, 20 and sealing rings 32, 34 is full hard SS301. The preferred material for the distance layer 24 is half hard SS430 stainless steel. The outermost layers 18, 20 have a thickness of about 0.25 mm. The thickness of the distance layer is preferably about 0.55 mm+/−0.05. The thickness of the sealing rings 32, 34 enables the beads 36, 38 to exert great sealing force under conditions of high engine compression and temperature. The beads 36, 38 in the sealing area 14 are to be limited to those provided by the sealing rings 32, 34 and are in the form of a pair of opposed sealing beads that face away from one another. As such, the bead portion 36, 38 of the sealing areas 14 made up of just two opposing beads 36, 38 of the sealing rings 32, 34 that surround each cylinder opening 12. The beads 36, 38 have a preferred width of about 2.6 mm+/−0.3 and a height of 0.5 mm+/−0.3. It is further preferred that the beads 36, 38 are pre-set. The beads 36, 38 are initially formed with an as-embossed height that it greater than the pre-set height. For example, the beads 36, 38 may have an as-embossed height of 0.15 mm+/−05 but then during manufacture are compressed flat under heavy load to impart controlled plastic deformation to the beads 36, 38 to achieve the resultant pre-set height of 0.05 mm+/=0.3 mm. The pre-set condition of the beads 36, 38 serves to toughen the beads and make them less prone to cracking in use under conditions of heavy compression load and temperature cycling. The combined thickness of the pre-set beads is greater than the thickness of the distance layer 24.

FIGS. 2 and 3 illustrate the gasket 10 in the pre-compressed and fully compressed conditions, respectfully. When fully clamped under load in use, the beads 36, 38 of the sealing rings 32, 34 are compressed flat, as illustrated in FIG. 3 to effect a fluid-tight seal about the cylinder opening 12, and are not restrained in doing so by the relatively thinner distance layer 24.

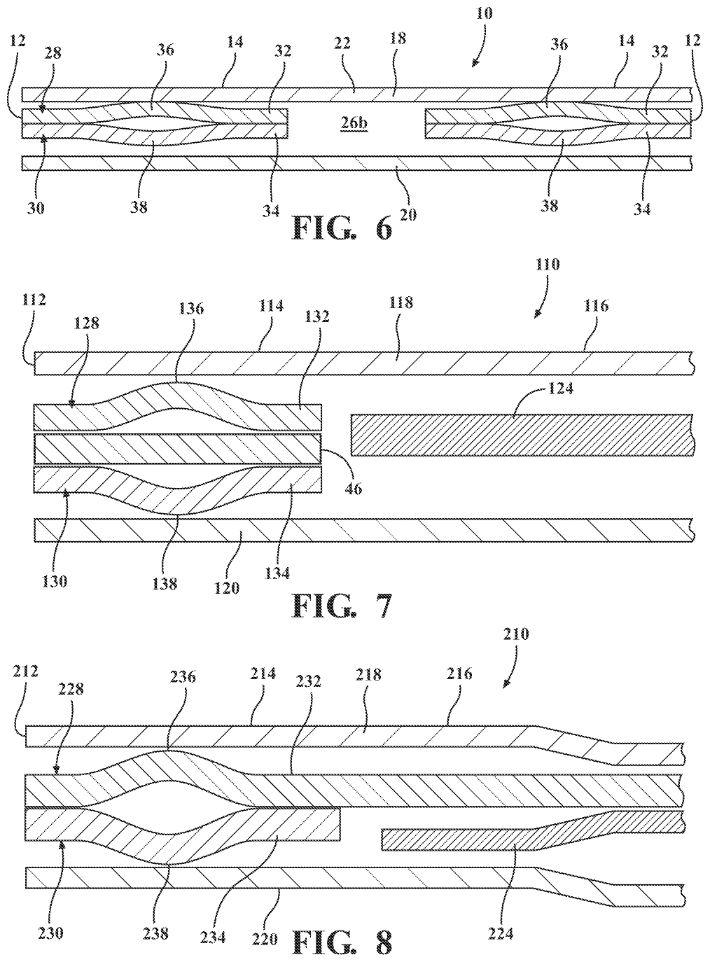

FIG. 7 illustrates an alternative embodiment, wherein the same reference numerals are used to identify like features in common with the first embodiment, but offset by 100. The gasket 110 is the same in construction as that of FIG. 1, but includes a further ring layer 46 interposed between each pair of opposed sealing rings 132, 134 to effect a thickening of the gasket 110.

FIG. 8 illustrates an alternative embodiment, wherein the same reference numerals are used to identify like features in common with the first embodiment, but offset by 200. The material of the functional layers 228, 230 is identical to that of the first embodiment and the layers 228, 230 include the opposed beads 236, 238 of the same type and arrangement, but the one of the layers 228 is extended beyond the sealing area 214. The distance layer 224 is thinner than the thickness of each functional layer 228, 230, but when combined with the extended portion of the top functional layer 228, the combined thickness remains less than the combined thickness of the functional layers 228, 230 in the sealing area 214, assuring that the beads 236, 238 can be compressed fully flat as with the first embodiment.

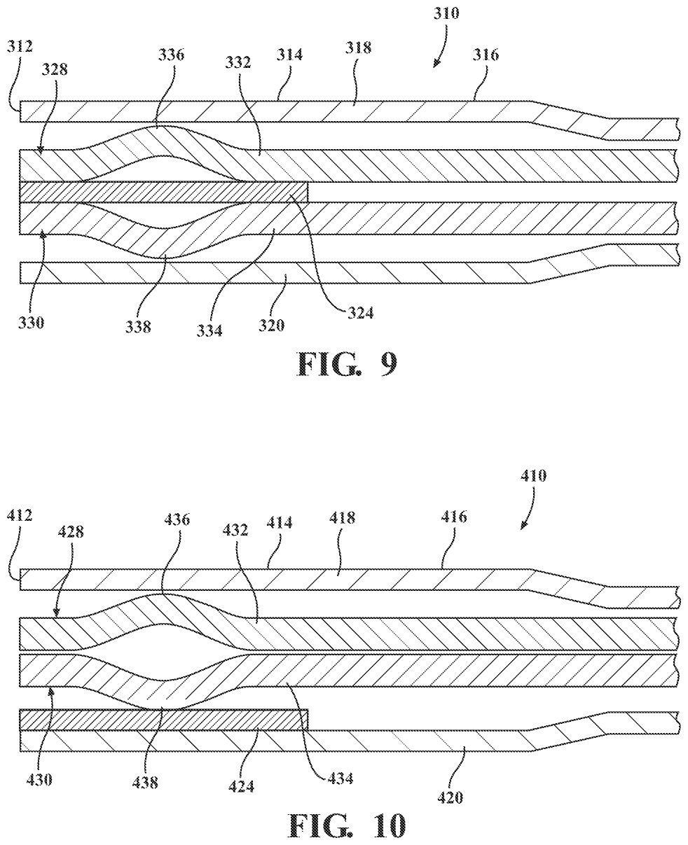

FIG. 9 illustrates an alternative embodiment, wherein the same reference numerals are used to identify like features in common with the first embodiment, but offset by 300. The combined material thickness of the layers in the sealing area 314 are greater than the combined material thickness of the layers in the body area 316, as with the other embodiments. The functional layers 328, 330 include the same opposed full beads 336, 338 in the sealing area 314, but both layers extend to the body area 316. The distance layer 324 in the firm of a ring is interposed between the beads 336, 338 to thicken the sealing area 314 relative to the adjacent body area 316 to achieve full flattening of the beads 336, 338 under load in use, as with the other embodiments.

FIG. 10 illustrates an alternative embodiment, wherein the same reference numerals are used to identify like features in common with the first embodiment, but offset by 400. The gasket 410 of FIG. 10 is identical to that of FIG. 9 except that the ring-shaped distance layer 424 is moved from between the beads 436, 438 the between one of the beads 438 and the adjacent outermost layer 420.

Common to all embodiments is that the functional layers (or ring portions) are at least 0.3 mm in thickness, they contain full beads surrounding the cylinder openings that face away from one another, the functional layers are made of the same material and have the same hardness as the outermost layers but the material of the functional layers is relatively thicker than the outermost layers, that at least one distance layer is provided between the outermost layers and is of a relatively softer steel material, and that the thickness of the gasket in the sealing area surrounding each cylinder opening is greater than the thickness of the gasket in the body area adjacent the sealing areas such that the sealing beads are compressed fully flat in use when clamped between a cylinder head and block of an engine. The various embodiments represent different constructions for achieving these objectives.

Obviously, many modifications and variations of the present invention are possible in light of the above teachings. It is, therefore, to be understood that the invention may be practiced otherwise than as specifically described while still being within the scope of the invention.

What is claimed is:

1. A multilayer steel cylinder head gasket for an internal combustion engine, comprising:
a pair of outermost layers fabricated of a first steel material having a first hardness and a first thickness, the pair of first layers including a plurality of combustion cylinder openings;
a distance layer fabricated of a second steel material having a second hardness and second thickness, the distance layer including an inner edge that surrounds each or all of the plurality of combustion cylinder openings of the outermost layers in radially outwardly spaced relation thereto;
a pair of opposing elastic sealing rings associated with each of the plurality of combustion cylinder openings; the sealing rings each being fabricated of a third steel material having a third hardness and each being formed with a full bead embossment the encircles the associated combustion cylinder openings, and with the full bead embossments of each pair of sealing rings projecting away from one another toward the outermost layers, the sealing rings being radially inset in relation to the inner edge of the distance layer; and
wherein the outermost layers and sealing rings are made of the same stainless steel material and have the same hardness, the material of the distance layer being different than that of the outermost layers and sealing rings and having a relatively lower hardness; and
wherein the sealing rings each have a thickness relatively greater than the thickness of each of the outermost layers; distance layer having a thickness greater than the thickness of each of the sealing rings and outermost layers; the thickness of the distance layer being less than twice the thickness of each of the sealing rings, and wherein the thickness of each of the sealing rings is at least 0.3 mm.

2. The gasket according to claim 1, wherein the outermost layers and sealing rings are made of SS301 full hard stainless steel.

3. The gasket according to claim 2, wherein the distance layer is made of SS430 half hard stainless steel.

4. The gasket according to claim 1 wherein the layers of the gasket consist of the two outer most layers, a set of the two sealing rings associated with each cylinder opening, and the distance layer.

5. The gasket according to claim 1, wherein the beads are compressed flat in use.

6. The gasket according to claim 5, wherein the thickness of the flattened beads is greater than the thickness of the distance layer immediately adjacent the flattened beads.

7. The gasket according to claim 1, wherein the beads of the sealing rings are pre-set prior to use so as to have a pre-set bead height less than an as-embossed bead height resulting from controlled plastic deformation of the beads.

8. The gasket according to claim 1 wherein the outermost layer extends fully between and separates adjacent ones of the plurality of combustion cylinder openings.

9. The gasket according to claim 8, wherein the inner edge of the distance layer does not extend fully between the adjacent ones of the plurality of the combustion cylinder openings.

10. The gasket according to claim 9, wherein the sealing rings are each generally circular and separately formed from one another and from the outermost layers and from the distance layer, and wherein each of the combustion cylinder openings is encircled by two of the sealing rings with their full beads arranged in direct opposing relation to one another, and wherein the sealing rings have outer edge tabs that underlie and are captured between the two outermost layers to support the sealing rings in position within their respective combustion cylinder openings.

11. A cylinder head gasket for an internal combustion engine, comprising:
a pair of outermost layers including a plurality of combustion cylinder openings;
a distance layer including an inner edge that surrounds each or all of the plurality of combustion cylinder openings of the outermost layers in radially outwardly spaced relation thereto;
a pair of elastic sealing rings associated with each of the plurality of combustion cylinder openings and having opposed full bead embossments that face away from one another; and
wherein the sealing rings have a material thickness of at least 0.3 mm and which is greater than a material thickness of the outermost layers.

12. The gasket according to claim 11, wherein the outermost layers and sealing rings are made of the same material composition and have the same hardness.

13. The gasket according to claim 12, wherein the distance layer is made of a different material composition and is relatively softer than a hardness of the outermost layers and sealing rings.

14. The gasket according to claim 11 wherein the inner edge is continuous and surrounds all of the plurality of combustion cylinder openings but does not extend fully between adjacent ones of the plurality of combustion cylinder openings.

15. A cylinder head gasket for an internal combustion engine, comprising:
a plurality of metallic gasket layers defining a plurality of combustion openings and including a sealing areas of the gasket encircling each cylinder opening and a body area of the gasket away from the sealing areas;
the plurality of metallic gasket layers including a pair of outermost layers, a pair of intermediate layers and at least one distance layer;
the intermediate layers including ring-shaped sealing portions surrounding each of the cylinder openings having full bead embossments that project away from one another toward the outermost layers; and wherein the sealing portions have a material thickness of at least 0.3 mm and the combined material thickness of all layers of material in the sealing areas are greater than a combined material thickness of all layers of material in the body of the gasket adjacent the sealing areas.

16. The gasket according to claim 16, wherein the inner layers are relatively thicker than the outermost layers.

17. The gasket according to claim 16, wherein the inner layers and the outermost layers are fabricated from the same material composition and have the same hardness.

18. The gasket according to claim 17, wherein the material composition is full hard SS301.

19. The gasket according to claim 16, wherein the distance layer is disposed between and/or adjacent to and/or above and/or below the inner layers.

20. A multi-layer steel gasket, comprising:
a pair of outermost steel layers having a plurality of combustion openings and wherein the outermost layers are generally planar and free of elastic beads in a compression region of the gasket immediately surrounding the combustion openings and each having a predetermined thickness;
a pair of metal sealing rings associated with each of the combustion openings disposed between the outermost layers and formed with opposed full beads in the compression region of the gasket around each cylinder opening and each having a thickness of at least 0.3 mm and which is greater than the thickness of the outermost layers; and
at least one distance layer disposed between the outermost layers, wherein when the compression region is fully compressed, the thickness of the combined layers of gasket in the compression region is greater than the thickness of the combined layers of the gasket in a body of the gasket adjacent the compression region.
